(19) United States
(12) Patent Application Publication
(10) Pub. No.: US 2002/0140975 A1
(43) Pub. Date: Oct. 3, 2002

(54) Method, system, and program for print order

(76) Inventor: Keisuke Tanaka, Kaisei-machi (JP)

Correspondence Address: BIRCH STEWART KOLASCH & BIRCH, PO BOX 747, FALLS CHURCH, VA, 22040-0747, US

(21) Appl. No.: 10/108,718

(22) Filed: Mar. 29, 2002

(30) Foreign Application Priority Data
Mar. 29, 2001 (JP) (PATENT)096168/01

(51) Int. Cl. B41J 1/00; G06K 1/00

(52) U.S. Cl. 358/1.15

(57) ABSTRACT

Information on an agency is input at the time of placing an order for printing image data via a network, without troublesome operation. A user connects a user terminal to a print order reception center via the network and carries out user registration by inputting the home address and the work address. An order reception server compares user information input at the user registration with the address of an agency stored in a database to display a candidate agency list corresponding to the user information. The user selects an agency from the list. The print order reception center delivers prints to the agency selected by the user.

### BACKGROUND OF THE INVENTION

1. Field of the Invention

The present invention relates to a print order method and a print order system for receiving an order for printing image data via a network. The present invention also relates to a program that causes a computer to execute the print order method.

2. Description of the Related Art

There have been known digital photograph service systems for carrying out various kinds of digital photograph services such as storing photographs obtained by users in image servers after digitization thereof, recording the photographs in CD-Rs to be provided to the users, printing images photographed by users with digital cameras, and receiving orders for additional prints. As one form of such digital photograph service systems, a network photograph service system for receiving print orders via a network such as the Internet has also been proposed.

In such a network photograph service system, a user installs viewer software in his/her personal computer, which acts as a user terminal, for reproducing image data recorded in a CD-R or obtained by a digital camera. The user reproduces images represented by the image data, and generates order information describing the content of an order by using an ordering function built-in to the viewer software if the user wishes to place an order. The user transfers the order information and the image data to be printed from the user terminal to an order reception server via the network such as the Internet. The order reception server transfers the order information and the image data to a printer server installed in a laboratory or in a mini-laboratory of a DPE store. The printer server prints the image data based on the order information, and generates an additional print, a picture postcard, or a photograph album. In the case where the order reception server and the printer server are located at the same place, printing is carried out immediately after reception of the image data and the order information.

The printed matter generated in the above manner is delivered to an agency specified by the user at the time of placing the order. In this manner, the user can receive the printed matter by paying a charge at the agency.

The order information herein referred to is information such as a processing number for specifying the content of a printing service (generation of ordinary prints or picture postcards or the like), an image number for specifying a photograph, a print size, a quantity of prints, specification of printing paper (such as glossy or non-glossy), thickness of the printing paper, the content of photographic processing, and trimming specification, for example. The order information may further include information regarding the name, the address, the zip code and the phone number of the user, for example.

Meanwhile, for placing the print order in the network photograph service system described above, the user needs to designate the agency at which the user receives the printed matter. The user can designate the agency by: (1) selecting the desired agency from a list of agencies displayed on the user terminal,; (2) selecting area information such as a prefecture by using the user terminal and then selecting the desired agency from a list of agencies in the selected area; (3) displaying the agency closest to the user on the user terminal, based on the zip code of the user; or (4) directly inputting the name of the agency from the user terminal, for example.

However, operation for selecting the agency is troublesome for the user, and designation of the agency without a troublesome operation has been desired.

### SUMMARY OF THE INVENTION

The present invention has been conceived based on consideration of the above circumstances. An object of the present invention is therefore to provide a method, a system, and a program that enable designation of an agency at which a user can receive printed matter without carrying out a troublesome operation.

A print order method of the present invention is a method used in a printing service system that provides printed matter according to a print order of a user regarding image data. The print order method comprises the step of:

displaying a candidate of an agency at which the user receives the printed matter, based on user information input by the user.

A print order system of the present invention comprises:

an order reception server for receiving a print order of a user regarding image data; and

a user terminal connected to the order reception server via a network and enabling the user to place the print order regarding the image data with the order reception server. The print order system is characterized by that the order reception server causes the user terminal to display a candidate of an agency at which the user receives printed matter, based on user information input by the user.

The order reception server is a server computer installed in a print order reception center or the like dedicated to print order reception. The order reception server is connected directly to a printer if the print order reception center has the printer. In the case where the print order reception center is not equipped with a printer, the order reception server is connected via the network to a printer server installed in a large-scale laboratory or in a mini-laboratory of a DPE store. The DPE store can act as an agency.

In the case where the order reception server is connected directly to the printer, the image data can be printed immediately after reception of the print order. Meanwhile, if the order reception server is connected to the printer server via the network, the order reception server transfers the image data and agency information to the printer server immediately after reception of the print order, and the printer server carries out the printing.

The user information refers to the home address of the user, the zip code thereof, the work address of the user, the zip code thereof, a station used by the user for commuting, or an agency used by the user in the past, for example.

The order reception server comprises correlation means for correlating the user information with latitude and longitude. In this manner, the order reception server can cause the user terminal to display the candidate agency based on the latitude and longitude correlated by the correlation means.

The user information may further include a span of business hours convenient for the user to use the agency.

In the print order system of the present invention, it is preferable for the user terminal to display an order Web screen based on information stored in the order reception server (such as an html file or Java Script) so that the user can place the print order via the order Web screen. In this manner, the user can place the print order through comparatively easy operation at any time convenient for him/her.

In the print order system of the present invention, it is also preferable for the user terminal to transfer order information representing the content of the print order to the order reception server.

A program that causes a computer such as the order reception server to execute the print order method of the present invention comprises the steps of:

receiving a print order;

detecting a candidate agency at which a user can receive printed matter, based on user information input by the user who places the print order; and

displaying the candidate agency.

According to the present invention, the candidate agency at which the user receives the printed matter is displayed based on the user information input by the user, that is, information indicating a location convenient for the user to receive the printed matter, such as the home address of the user, the work address thereof, or a place on a commuting path. Therefore, the user can easily designate an agency convenient for him/her to receive the printed matter, without carrying out a troublesome operation.

### BRIEF DESCRIPTION OF THE DRAWINGS

FIG. 1 is a block diagram showing a configuration of a network photograph service system adopting a print order system of a first embodiment of the present invention;

FIG. 2 is a flow chart showing a procedure carried out in the first embodiment;

FIG. 3 is a flow chart showing an operation for print order processing;

FIG. 4 is a flow chart showing a procedure of agency confirmation;

FIG. 5 shows a user registration Web screen;

FIG. 6 shows a station information input Web screen;

FIG. 7 shows an agency search Web screen;

FIG. 8 shows a reception time designation Web screen;

FIG. 9 shows an candidate agency list Web screen (case 1);

FIG. 10 shows a user information table (case 1);

FIG. 11 shows a store information table (case 1);

FIG. 12 shows the store information table (case 2);

FIG. 13 shows a zip code table;

FIG. 14 is a flow chart showing a procedure carried out in a third embodiment of the present invention;

FIG. 15 shows the user information table (case 2);

FIG. 16 shows an agency use history table;

FIG. 17 shows the candidate agency list Web screen (case 2); and

FIG. 18 shows an candidate agency display Web screen.

### DESCRIPTION OF THE PREFERRED EMBODIMENTS

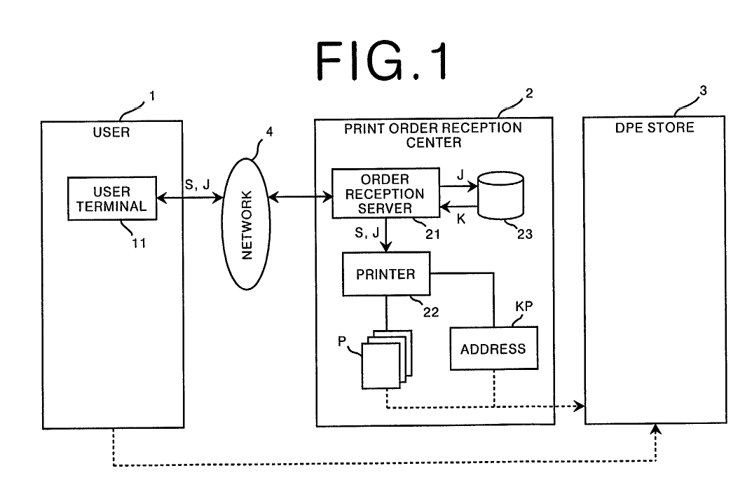

Hereinafter, embodiments of the present invention will be explained with reference to the accompanying drawings. FIG. 1 is a block diagram showing a configuration of a network photograph service system adopting a print order system of a first embodiment of the present invention. In the network photograph service system shown in FIG. 1, data, prints, and the like are exchanged between a user 1, a print order reception center 2, and a DPE store 3.

The user 1 has a user terminal 11 such as a personal computer. The user 1 can place a print order with the print order reception center 2 via a network 4. In the case where the user 1 does not have a personal computer, the user 1 can use an order terminal installed in a service station or the like as the user terminal 11.

The print order reception center 2 has an order reception server 21 for receiving the print order, a printer 22 for obtaining a print or prints P (hereinafter referred to as the printsP) based on image data S transferred from the user terminal 11 via the network 4 at the time of placing the print order, and a database, 23 for storing agency address information K. The printer 22 generates a label KP on which an agency address is printed based on the agency address information K. In this manner, the print order reception center 2 delivers the prints P to the agency address (to the DPE store 3 in this embodiment) by pasting the label KP on a bag containing the prints P, for example.

The user 1 can browse through and manipulate the image data S, and can place the order by using the user terminal 11. At the time of placing the print order, the user terminal 11 accesses the order reception server 21 in the print order reception center 2 by using a function of Web browser software installed in the user terminal 11. Based on information such as an html file or Java Script stored in the order reception server 21, an order Web screen is displayed on the user terminal 11. The print order is placed via the order Web screen.

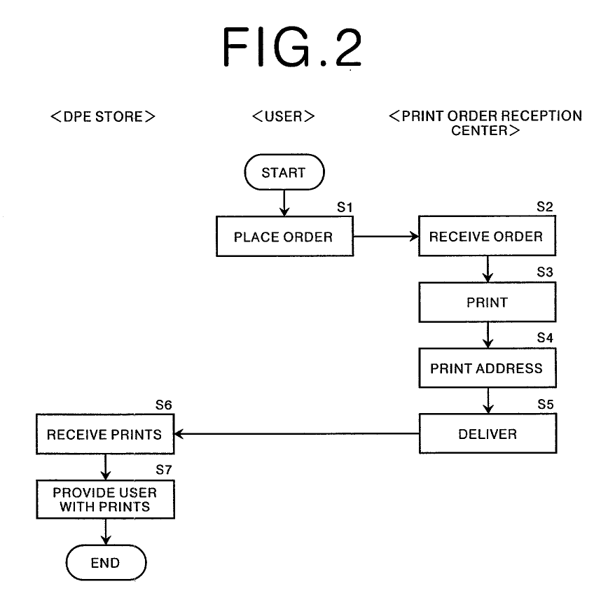

Operation of the first embodiment will be explained next. FIG. 2 is a flow chart showing a procedure carried out in the first embodiment.

The user 1 browses through images, manipulates each image to be printed, (and places the print order (Step S1). The print order is transferred to the order reception server 21 in the print order reception center 2, and the order is received (Step S2). Hereinafter, the procedure at Step S1 and Step S2 will be explained in detail.

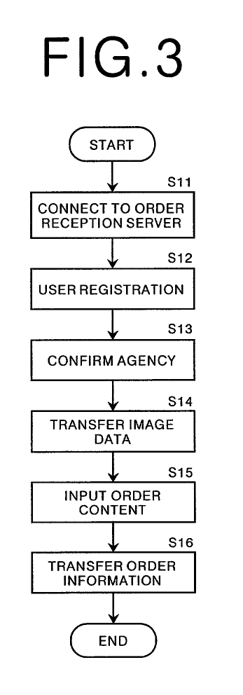

FIG. 3 is a flow chart showing operation of print order processing. The user terminal 11 is connected to the order reception server 21 in the print order reception center 2 via the network 4 by the function of the Web browser software installed in the user terminal 11 (Step S11). At this time, the order Web screen is displayed on the user terminal 11, based on the information stored in the order reception server 21. The user 1 inputs the home address or the work address or the like (hereinafter referred to as user information J) for receiving a service, and carries out user registration (Step S12). The order reception server 21 searches for candidates of an agency at which the user can receive the prints P, based on the user information J, and displays an candidate agency list. The user 1 selects the agency from the list displayed thereon (Step S13). Hereinafter, the procedure at Step S12 and Step S13 will be explained in detail.

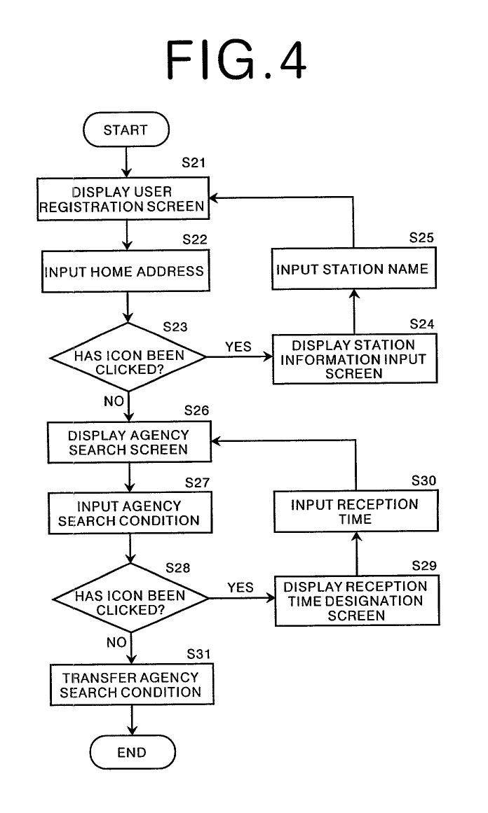

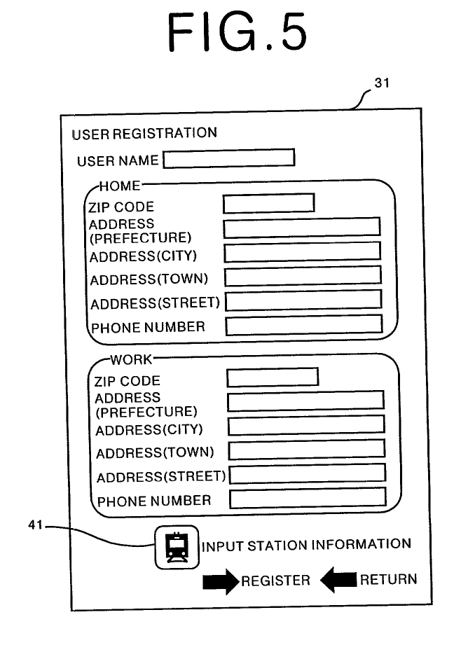

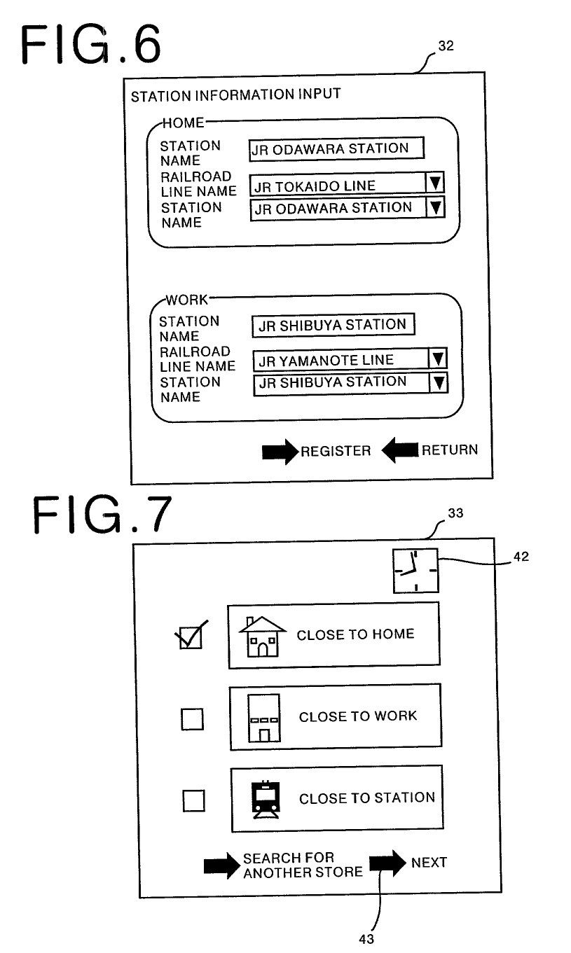

FIG. 4 is a flow chart showing a procedure for displaying the candidate agency list. A user registration Web screen 31 is displayed on the user terminal 11 at the time of user registration, as shown in FIG. 5 (Step S21). The user 1 inputs the zip codes, the addresses, and the phone numbers of his/her home and work place (Step S22). The user 1 then clicks an icon 41 in the user registration Web screen 31 (Step S32). A station information input Web screen 32 is displayed on the user terminal 11, as shown in FIG. 6 (Step S24) The user can input station names and a railroad line name or railroad line names closest to his/her home and work addresses. By inputting the information in the station information input Web screen 32 (Step S25), the list of candidate agencies can be displayed.

The information input in the user registration Web screen 31 (the zip codes, the addresses, and the phone numbers of the user's home and work place) and the information input in the station information input Web screen 32 (the station names and the railroad line name or names closest to his/her home and work addresses) is then transferred as the user information J to the order reception server 21.

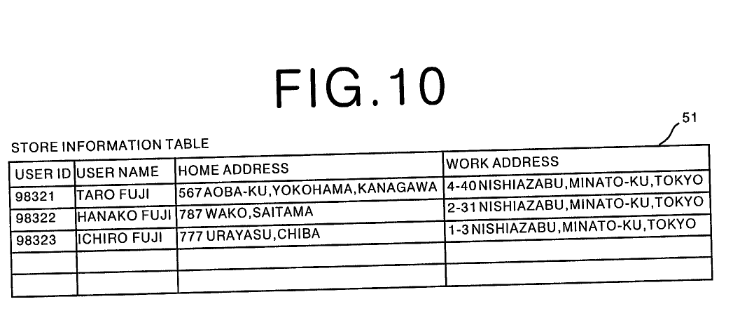

The order reception server 21 receives the user information J and stores the user information J in a user information table 51 in the database 23. An example of the user information table 51 is shown in FIG. 10. The order reception server 21 also displays an agency search Web screen 33 on the user terminal 11, as shown in FIG. 7 (Step S26).

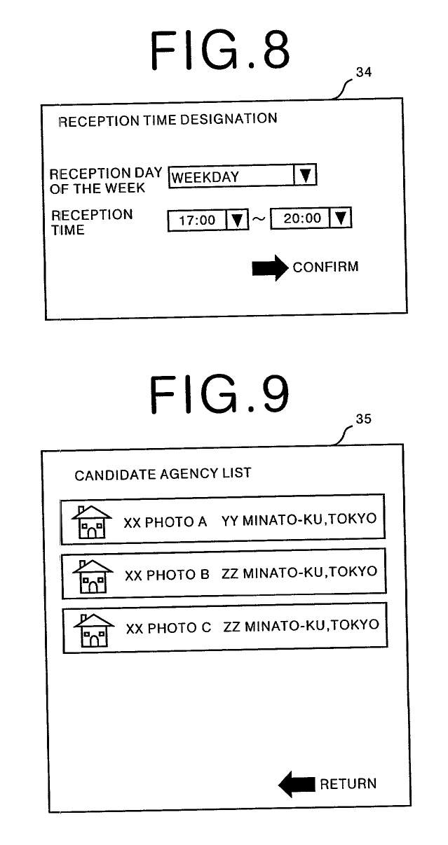

The user 1 selects one of check boxes “close to home”, “close to work”, and “close to station” displayed in the agency search Web screen 33 (Step S27) The checkbox “close to station” is displayed only in the case where the user 1 has input the station names and the railroad line name or names close to his/her home and work addresses. If the user 1 clicks an icon 42 in the agency search Web screen 33 (Step S28), a reception time designation Web screen 34 is displayed on the user terminal 11, as shown in FIG. 8 (Step S29). The user 1 can further add the day of the week and business hours to an agency search condition (Step S30). In this embodiment, the user 1 is assumed to have selected the check box “close to home”, and reception time designation is not carried out. By inputting the agency search condition and clicking an icon 43, agency search condition information is sent to the order reception server 21 (Step S31).

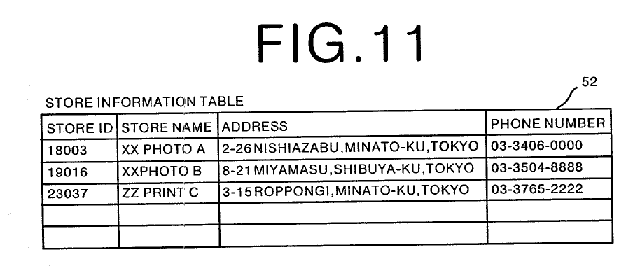

The order reception server 21 receives the agency search condition information and searches for the candidate agencies. In this embodiment, since “close to home” has been selected as the search condition, the home address of the user 1 stored in the user information table 51 in the database 23 is compared with the address of each DPE store stored in an agency information table 52 shown in FIG. 11. The order reception server 21 searches for any DPE store close to the home address in this manner, and transfers a search result to the user terminal 11. An candidate agency list Web screen 35 is displayed on the user terminal 11, as shown in FIG. 9. The user 1 selects one of the candidate agencies from the list displayed in the candidate agency list Web screen 35 as desired.

Once the agency has been determined in the above manner, an image uploading Web screen (not shown) is displayed on the user terminal 11. Image uploading, that is, transfer of the image data S to the order reception server 21 is carried out by using the image uploading Web screen (Step S14).

After completion of image uploading, an order content input Web screen (not shown) is displayed on the user terminal 11. On the order content input Web screen are displayed a charge for each print size, a number of each image that has been uploaded, a thumbnail image thereof, the file name thereof, the uploading time and date, a print size selection field, and a print quantity input field.

The uploaded images are displayed in order of file names. The user I can confirm the images that have been uploaded, the file names thereof, and the uploading time and date while viewing the order content input Web screen. The print size selection field comprises a pull-down menu, and L size with white margin/without, eclipse, L size without white margin/with eclipse, DSC size, DSCW size, and 2L size are selectable, for example. A quantity of prints can be input directly in the print quantity input field.

The user 1 inputs the content of the order in the order content input Web screen (Step S15), and clicks an “Order Confirmed” button. The content of the order is then sent as order information to the order reception server 21 (Step S16) to end the procedure.

The order reception server 21 in the print order reception center 2 receives the order information as shown in FIG. 2 (Step S2), and prints the image data S based on the order information to generate the prints P (Step S3). The label KP on which the agency address information K is printed is also generated, based on the user information J (Step S4). The label KP is pasted on the bag containing the prints P, and the bag is delivered to the address (Step S5). The DPE store 3 receives the prints P (Step S6). The user visits the DPE store 3 and receives the prints P by paying a charge (Step S7) to end the whole operation.

As has been described above, in this embodiment, the list of candidates of the agency at which the user 1 receives the prints P is displayed based on the user information J input by the user 1. Therefore, the user 1 can designate the agency at which to receive the prints P, without carrying out a troublesome operation. In this manner, the print order can be placed easily.

In the above embodiment, “close to home” has been specified as the agency search condition. However, “close to work” or “close to station” can also be used as the agency search condition. Furthermore, the reception time can also be added to the search condition.

A second embodiment of the present invention will be explained next. A network photograph service system in the second embodiment has the same configuration as in the first embodiment. Therefore, the same reference numbers are used and detailed explanation of the system is omitted.

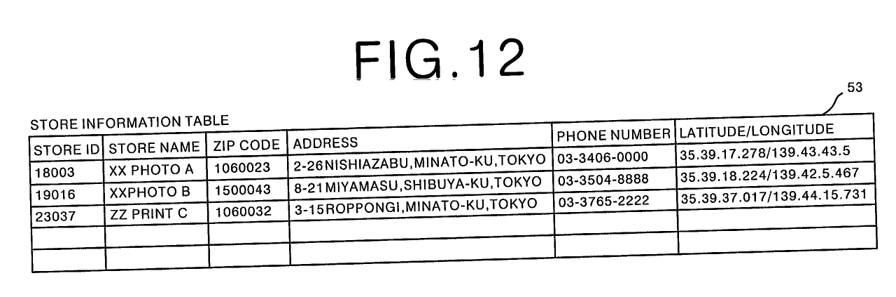

In the second embodiment, a database 23 stores a store information table 53 relating the address of each agency with latitude and longitude thereof, as shown in FIG. 12.

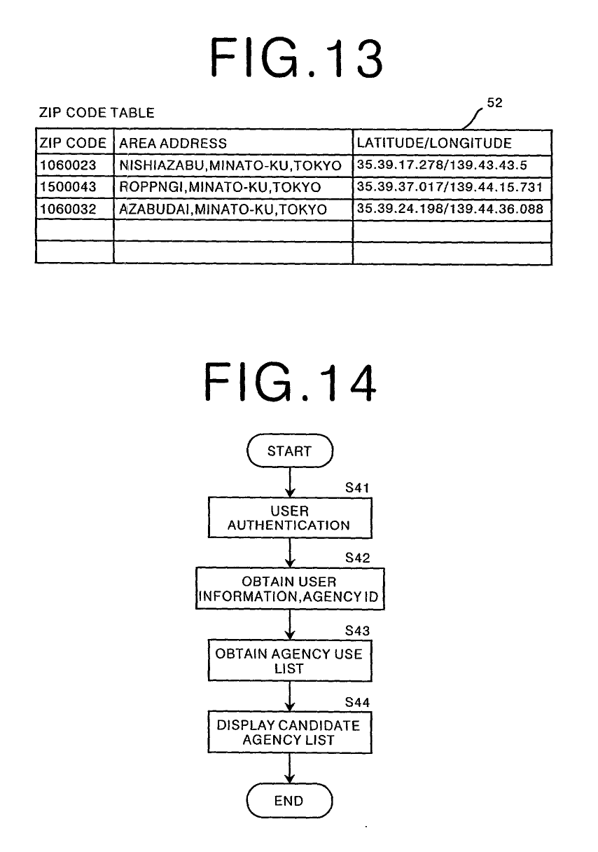

In the case where “close to home” is specified as a search condition for the candidate agency search, an order reception server 21 compares the home zip code of a user 1 stored in a user information table 51 with a zip code table 54 shown in FIG. 13, and finds the latitude and longitude corresponding to the home zip code. The order reception server 21 further compares the latitude and longitude corresponding to the home address of the user 1 with the latitude and longitude of each agency stored in the store information table 53. In this manner, the order reception server 21 searches for DPE stores close to the address of the user 1 and transfers the search result information to a user terminal 11.

In the second embodiment, candidate agencies are searched for based on the latitude and longitude corresponding to the address of the user 1. Therefore, the candidate agencies can be determined based on distance rather than a place name. In this manner, a list of the candidate agencies close to a location desired by the user 1 can be displayed more accurately.

In the second embodiment, “close to home” has been specified as the search condition. However, “close to work” or “close to station” can also be used for the candidate agency search. Furthermore, reception time can also be added to the agency search condition.

A third embodiment of the present invention will be explained next. In the third embodiment, a network photograph service system has the same configuration as in the first embodiment. Therefore, the same reference numbers are used and detailed explanation thereof is omitted.

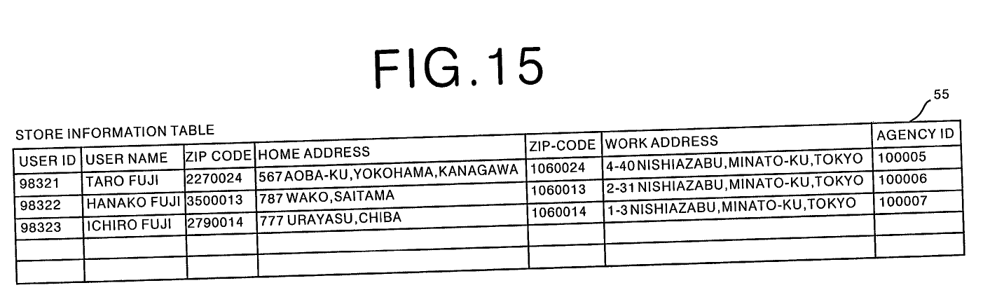

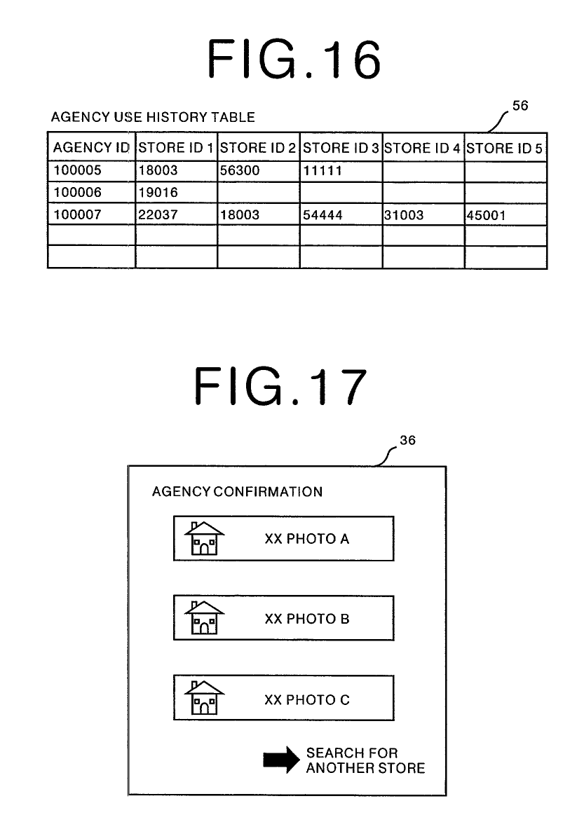

In the third embodiment, a database 23 stores a user information table 55 relating a user with an ID of an agency used by the user in the past, as shown in FIG. 15. Furthermore, the agency ID is related to a store ID or store IDs (hereinafter referred to as the store IDs), as shown by an agency use history table 56 shown in FIG. 16.

Operation of the third embodiment will be explained next. FIG. 14 is a flow chart showing a procedure carried out in the third embodiment.

The user 1 connects a user terminal 11 with an order reception server 21 in a print order reception center 2 via a network 4, by using Web browser software installed in the user terminal 11. At this time, an order Web screen is displayed on the user terminal 11, based on information stored in the order reception server 21. The user 1 inputs information necessary for placing a print order, such as a user ID and a password in the Web screen, and connects the user terminal 11 to the order reception server 21 (Step S41).

In the case where a DPE store or DPE stores (hereinafter referred to as the DPE stores) used by the user 1 in the past are to be shown as candidate agencies, the order reception server 21 searches the database 23 for the ID of the agency used by the user 1 in the past (Step S42), and searches for the store IDs related to the agency ID that has been found (Step S43). A result of the DPE stores corresponding to the store IDs is then transferred to the user terminal 11 and displayed thereon as the candidate agencies. At this time, a candidate agency list Web screen 36 is displayed on the user terminal 11, as shown in FIG. 17 (Step S44).

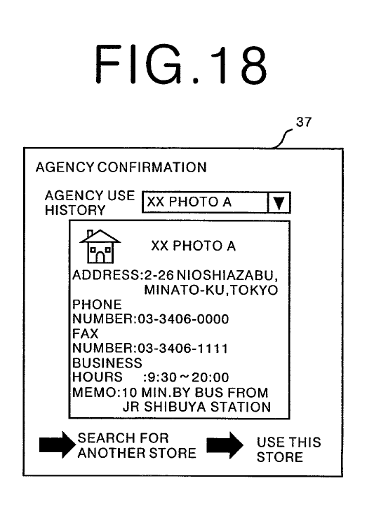

The user 1 selects one of the stores from the list of the candidate agencies displayed in the candidate agency list Web screen 36. Alternatively, a pull-down menu can be displayed as shown by a candidate agency display Web screen 37 shown in FIG. 18. The user 1 selects the desired agency from the list shown in the candidate agency list Web screen 36.

What is claimed is:

1. A print order method used in a printing service system that provides printed matter according to a print order of a user regarding image data, the print order method comprising the step of:
displaying a candidate of an agency at which the user receives the printed matter, based on user information input by the user.

2. A print order system comprising:
an order reception server for receiving a print order of a user regarding image data; and
a user terminal connected to the order reception server via a network and enabling the user to place the print order regarding the image data with the order reception server, wherein
the order reception server causes the user terminal to display a candidate of an agency at which the user receives printed matter, based on user information input by the user.

3. A print order system as defined in claim 2, wherein the user information represents a home address of the user.

4. A print order system as defined in claim 2, wherein the user information represents the zip code of a home address of the user.

5. A print order system as defined in claim 2, wherein the user information represents a work address of the user.

6. A print order system as defined in claim 2, wherein the user information represents the zip code of a work address of the user.

7. A print order system as defined in claim 2, wherein the user information represents a station used by the user for commuting.

8. A print order system as defined in claim 2, wherein the user information represents an agency used by the user in the past.

9. A print order system as defined in any one of claims 2 to 8, the print order system further comprising correlation means for correlating the user information with latitude and longitude, and the order reception server causing the user terminal to display the candidate agency based on the latitude and longitude correlated by the correlation means.

10. A print order system as defined in claim 2, wherein the user information further represents a span of business hours desired by the! user.

11. A print order system as defined in claim 2, wherein the user terminal displays an order Web screen for placing the print order, based on information stored in the order reception server.

12. A print order system as defined in claim 2, wherein the user terminal further transfers order information representing the content of the print order to the order reception server.

13. A computer readable recording medium storing therein a program that causes a computer to execute print order reception processing for receiving a print order regarding image data by using an order reception server, the program comprising the procedures of:
receiving the print order;
detecting an candidate agency at which a user can receive printed matter, based on user information input by the user who places the print order; and
displaying the candidate agency.
